(19) United States
(12) Patent Application Publication
(10) Pub. No.: US 2004/0163134 A1
(43) Pub. Date: Aug. 19, 2004

(54) Digital television set with gaming system emulating a set top box

(76) Inventor: Daniel Willis, Stittsville (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/775,195

(22) Filed: Feb. 11, 2004

Related U.S. Application Data
(63) Continuation-in-part of application No. 10/232,602, filed on Sep. 3, 2002.

(51) Int. Cl. H04N 7/173

(52) U.S. Cl. 725/133; 725/141; 725/153

(57) ABSTRACT

A gaming system is disclosed. The gaming system includes a gaming console, which comprises a processor and a storage medium, and is in connection with a network, a monitor and a sound system, the method. First instruction data are received from an external storage medium read by the gaming console. These instruction data and include one of set-top instruction data for receiving and decoding digital broadcast data and set-top applications when executed on the gaming console, and communication data for use in retrieving via the network the set-top instruction data for receiving and decoding digital broadcast data and set-top applications when executed on the gaming console. The set-top instruction data are executed on the gaming console, and encoded digital broadcast data is received via the network. The received, encoded digital broadcast data are decoded and displayed on the monitor and on the sound system. The gaming system is therefore functioning as a set-top box.

This application is a continuation-in-part of U.S. patent application Ser. No. 10/232,602 filed Sep. 03, 2002.

### FIELD OF THE INVENTION

The present invention generally relates to video service systems, and more specifically to systems combining access to gaming services with access to digital television broadcast and access to the Internet.

### BACKGROUND OF THE INVENTION

A recent advancement in the area of communication media is digital television (DTV) broadcast, which is transmission of television signals using digital rather than conventional analog methods. DTV offers many advantages over analog TV, including superior image resolution for a given bandwidth, smaller bandwidth for a given image resolution, compatibility with computers and the Internet, superior audio quality, consistency of reception over varying distances, capacity for multicasting, and interactivity and interactive TV (ITV). To access DTV and ITV services, a DTV set including a set-top box as well as a receiver is necessary to television viewers, who wish to use their current analog television sets to receive digital broadcasts. The two standards of display formats for digital television transmissions are standard definition television (SDTV) and high definition television (HDTV). Presently, DTV in the HDTV format is often intertwined with Satellite TV, since cable providers across the US are lagging behind, and making HDTV set owners turn to off-the-air broadcasts and satellite television.

At the same time, new and exciting developments are taking place in computer gaming using gaming consoles (GC), and especially in interactive on-line computer gaming.

During the last couple of years, on-line computer gaming has gained increasing popularity, and today thousands of players are playing on-line all around the world. Many people stereotype these players as techno kids only, but this could not be more wrong. Both females and males of all ages can be found daily trying to out-think, out-maneuver, or just having a good time on-line. It is predictable that interactive on-line computer gaming will blur the line between games and other entertainment or communication media, and that the avenues explored in the development of on-line gaming might well break new ground for interactive Internet applications in all areas of business relations and social life.

The idea of combining gaming and television experiences is not a new concept. Nevertheless, the general idea is under continuous development, and new improvements are constantly introduced. For example, in U.S. Pat. No. 6,264,559 to Lawrence et al., issued Jul. 24, 2001, an interactive television system is described. The interactive television system includes a set top box and a remote control unit having an input device and control logic. The control logic processes input signals to transmit television control signals to control television programming, and is configured to execute game software instructions stored on a local medium and to process input signals to play the game. Further, the set top box interacts with the remote control unit during gaming.

However, all of the known systems combining gaming and television experiences have in common that a gaming console (GC) adapts a game for being played on an analog television set. If the analog television set is further used to receive digital television broadcast, an additional DTV set is needed to receive a digital television signal, and to adapt the digital television signal to be capable of display on an analogue television or to extract data from a digital television signal for display on a television.

### OBJECT OF THE INVENTION

It is therefore an object of the instant invention to provide a digital television set that is more commonly available and at a reduced cost to a consumer.

### SUMMARY OF THE INVENTION

In accordance with an aspect of the instant invention, there is provided a digital television set system comprising a receiver for receiving digital television signals from at least a communication channel; and a gaming console for use as a gaming client, the gaming console connected to the receiver and comprising: at least a volatile storage medium for having stored therein client instruction data relating to a gaming client and game instruction data relating to a current game in execution; at least an external storage medium reading circuit for sensing data from an external storage medium and for storing the received data in the at least a volatile storage medium; and at least a processor in communication with the at least a volatile storage medium, the processor for retrieving game instruction data therefrom for executing a game on the gaming console, and for retrieving client instruction data therefrom for executing a gaming client function on the gaming console; wherein when set-top client instruction data and set-top application instruction data are stored in the at least a storage medium and are executed on the at least a processor, the gaming console emulates a set-top box for use in displaying video information extracted from digital television signals.

In accordance with an aspect of the instant invention, there is further provided a method for emulating a set-top box on a gaming console, the gaming console being part of digital television set system and coupled to a receiver for receiving digital television signals from at least a communication channel, the gaming console comprising at least a processor and at least a storage medium, and being in connection with a monitor and a sound system, the method comprising the steps of receiving first instruction data from an external storage medium read by the gaming console and including one of set-top instruction data for receiving and decoding digital broadcast data when executed on the gaming console and communication data for use in retrieving via the receiver the set-top instruction data for receiving and decoding digital broadcast data when executed on the gaming console; executing the set-top instruction data on the gaming console; receiving encoded digital broadcast data via the receiver; decoding the received, encoded digital broadcast data; and displaying the decoded digital broadcast data on the monitor and on the sound system.

### BRIEF DESCRIPTION OF THE DRAWINGS

An exemplary embodiment of the present invention will be described in conjunction with the following drawings, in which similar reference numbers designate similar items:

FIG. 1 shows a schematic diagram of a digital television system;

FIG. 2 shows a schematic diagram of a gaming console according to the instant invention;

FIG. 3 displays a flow chart illustrating a procedure of playing a game on a gaming console;

FIG. 4 displays a flow chart illustrating a procedure of emulating a set-top box with a gaming console; and

FIG. 5 displays a flow chart illustrating a procedure of emulating a set-top box with a gaming console, and considering aspects of conditional access.

### DETAILED DESCRIPTION OF THE INVENTION

The instant invention is now described with respect to a specific embodiment thereof, in which a DTV system includes a gaming console configured to operate as a set-top box. Of course, the invention described herein is not restricted to a particular example, which will be described in what follows, but equally applies to other gaming devices emulating set-top boxes.

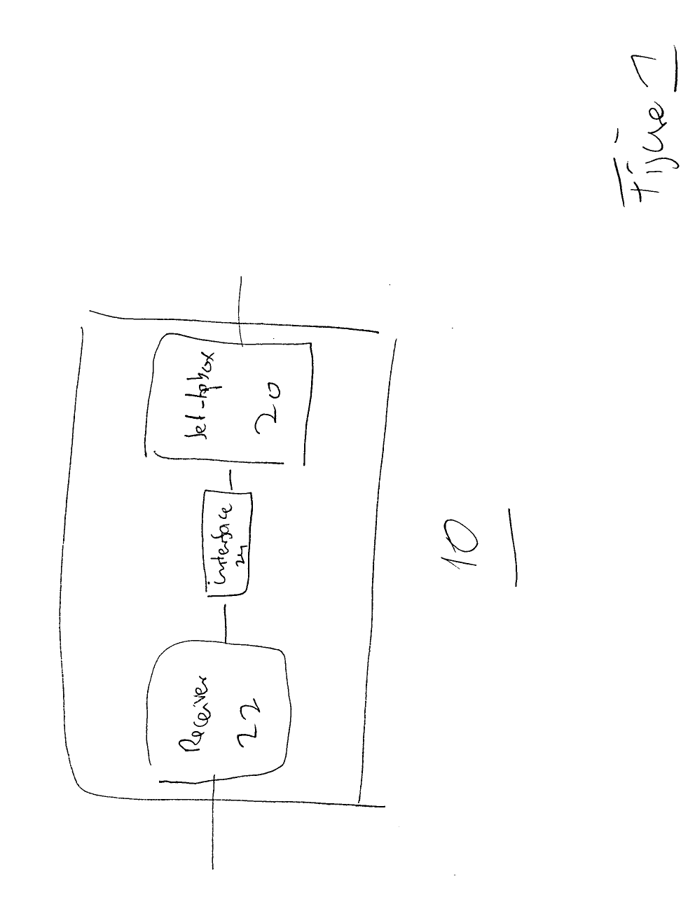

Referring to FIG. 1, shown is a schematic diagram of a digital television (DTV) system 10 for use with a conventional analog television set. The DTV system 10 comprises a set-top box type unit 20, a receiver unit 22, and an interface 24. The set-top box type unit 20 fulfils the function of a set-top box. It is for example a genuine set-top box, or a gaming console emulating a set-top box. A set-top box type unit (STB) is to be understood as electronic device designed to produce output on a conventional television set connected to some communications channels such as telephone, ISDN, optical fibre, or cable. Optionally, the STB runs software to allow the user to interact with the programs shown on the television in some way. The receiver unit 22 receives DTV signals from a communication channel, and passes the DTV signal to the set-top box type unit. Optionally, the STV signals are related to satellite television broadcast. The set-top box type unit 20 and the receiver unit 22 are coupled by an interface 24. The interface 24 is for example an IEEE 1394-1995 interface (a 1394 interface). The 1394 interface creates a two-way digital bus architecture. Digital devices are possibly daisy-chained together as opposed to using point-to-point connections. The 1394 interface is not only a set-top box to receiver connection, but it possibly connects several digital devices. A person of skill in the art easily envisions other interfaces. Further, the set-top box type unit 20, the receiver unit 22, and the interface 24 form a single integrated DTV set system 10.

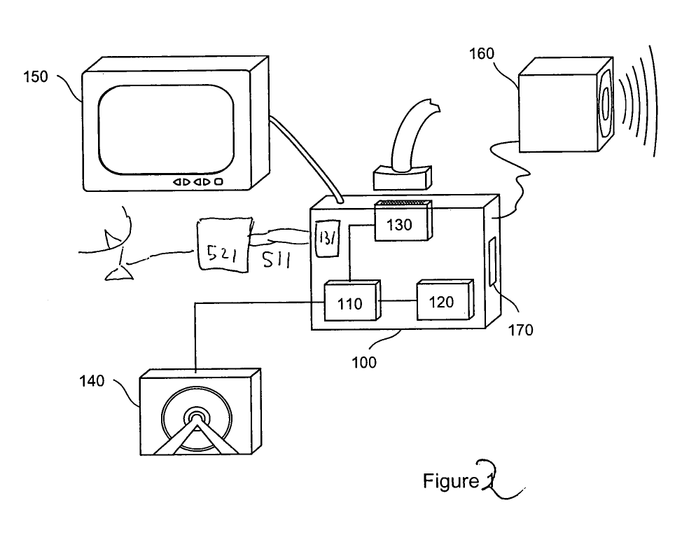

As mentioned before, it is possible that a gaming console emulating a set-top box is used as set-top box type unit 20. Referring now to FIG. 2, a schematic diagram of a gaming console (GC) according to the instant invention is shown. The gaming console 100 includes at least a storage medium 110, at least a processor 120, and a transceiver 130. The at least a storage medium 110 is for storing game instruction data relating to a current game in execution on the GC 100, as well as for storing client instruction data relating to a gaming client, the gaming client selecting and coordinating events taking place on the gaming console 100. Preferably, the gaming client is an ultra-thin client (UTC). The storage medium 110 comprises at least one of non-volatile random access memory, random access memory, and read-only memory. The at least a processor 120 is in communication with the storage medium 110 for receiving client instruction data and game instruction data, the client instruction data and the game instruction data to be executed on the at least a processor 120. Further, the at least a processor 120 includes at least an external storage medium reading circuit for sensing data from an external storage medium and for storing the received data in the at least a storage medium 110. The external storage medium is either a local external storage medium, or a remote external storage medium. For example, service provider facilities serve as remote external storage medium, and are accessed via a network. The transceiver 130, being in communication with the at least a storage medium 110, is for establishing a connection to at least one network, the at least one network possibly being a broadband access network. A gaming service provider possibly offers services over the at least one network. Preferably, the connection to the at least one network is established via a receiver, the receiver being in communication with at least a communication channel. The gaming service provider offers client instruction data and/or game instruction data, which are loaded over the at least one network into the at least a storage medium 110. Optionally, the GC 100 is in communication with an external storage medium 140, the external storage medium being a compact disc, read-only memory cartridge, or any other storage medium, for receiving client instruction data and/or game instruction data from the external storage medium 140, the data to be stored in the at least a storage medium 110, and to be executed by the at least a processor 120. The gaming console 100 is in communication with a monitor 150 and with a sound system 160, for displaying graphical images and sound, both produced by the at least a processor 120, when executing client instruction data and game instruction data. Optionally, the monitor is a monitor included in a television set. Additionally, the GC 100 is in connection with peripheral devices such as a keyboard, joysticks, and the like (not shown). Further optionally, the gaming console 100 comprises an interface 170 for accepting a smart card, or a related security device, the interface in communication with the at least a storage medium 110 and the at least a processor 120. The GC also includes another transceiver 131 being coupled to a television signal receiver 521 via an interface 511. Preferably, the television signal receiver is a satellite television signal receiver. Optionally, the transceiver 130 and the other transceiver 131 are a same transceiver.

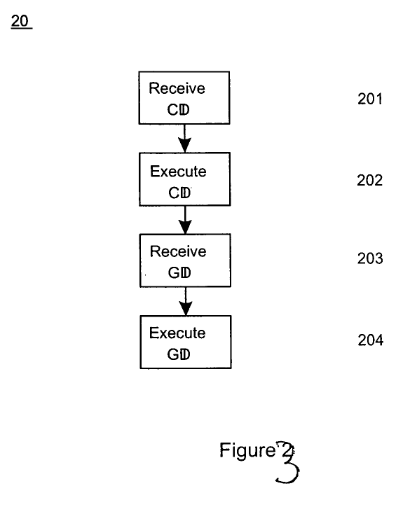

Referring now to FIG. 3, a flow chart is shown illustrating a procedure 20 for playing a game on the gaming console 100. In a first step 201, client instruction data (CID) a received, and stored in the at least a storage medium 110. The CID is received over a network, or from the external storage medium 140. Alternatively, the CID is received only once, and is stored in a non-volatile random access memory section of the at least a storage medium 110. Further alternatively, existing CID is replaced and/or updated by new CID. The CID is executed by the at least a processor 120, step 202. A gaming client is now running on the gaming console 100. The gaming client selects and coordinates events taking place on the gaming console. Next, gaming instruction data (GID) are received, step 203. The at least a processor 120 executes the GID, step 204. A game is now in execution on the gaming console 100. The steps 201, 202, 203, and 204 are either executed sequential, or they are executed in parallel. Also, depending on the nature of the CID and GID, the procedure possibly steps back to a step previously performed, and repeats the step.

Typically, all the CID and GID are a same application loaded from a storage medium and for, in execution, providing a user with a desirable gaming experience. As such, it might be considered that the CID and GID are a same dataset. That said, for ease of description and reference, they will be labeled separately herein.

When the client instruction data (CID) and the game instruction data (GID) stored in the at least a storage medium 110 are for emulating a set-top box—set-top client instruction data (STCID) and set-top game instruction data (STGID), and when the set-top client instruction data (STCID) and set-top game instruction data (STGID) are executed by the at least a processor 120, the gaming console 100 emulates a set-top box. Generally, a set-top box is either a device that enables a television set to run applications related to the Internet and/or a device that enables a television set to receive and decode digital television (DTV) broadcasts. However, set-top boxes are not restricted to be used with televisions sets only, but for example are used with gaming consoles connected to a monitor and a stereo. In the Internet realm, a set-top box emulates a specialized computer for communication with the Internet. It contains a Hypertext Transfer Protocol (HTTP) client, i.e. a Web browser, and it runs the Internet's main protocol, i.e. the Transmission Control Protocol/Internet Protocol (TCP/IP). The service to which the set-top box is attached, is possibly provided through a telephone line, through a cable TV company network, or through any other broadband access network. In the DTV realm, a typical digital set-top box contains at least a processor for running an operating system, possibly Linux or Windows CE, and for parsing a digital data transport stream. A set-top box also includes random access memory, and is capable of decoding and processing the digital data transport stream. Optionally, set-top boxes contain a hard drive for storing recorded television broadcasts, for downloaded software relating to set-top box operation, and for other applications provided by a DTV service provider.

When emulating a set-box, the set-top client instruction data (STCID) relate to a set-top client, which when executed by the at least a processor 120, fulfills the tasks of connecting to a network, and of receiving a digital data transport stream. The set-top game instruction data (STGID) relate to a “game” of decoding a digital data transport stream, and displaying the decoded data. For example, the DTV broadcast signal is most often offered in the Moving Picture Experts Group (MPEG) format. Thus, when executing the set-top game instruction data, the at least a processor 120 functions as an MPEG decoder. Further, the at least a processor 120 also functions as a processor for audio decoding and processing. Optionally, game instruction data (GID) and the set-top game instruction data (STGID) are application instruction data (AID) and set-top application instruction data (STAID), referring to any application received, stored, and executed on the gaming console 100.

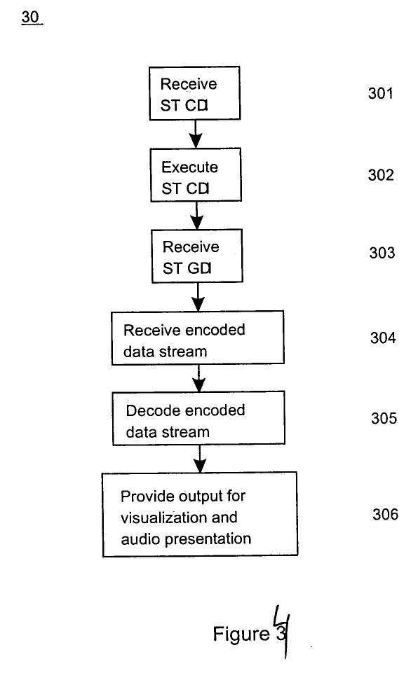

Referring now to FIG. 4, a flow chart is presented illustrating a procedure 30 of emulating a set-top box with a gaming console. The procedure 30 is related to the above-described procedure 20, and exemplifications and illustrations made for the procedure 20 equally apply to the procedure 30. In a first step 301, set-top client instruction data (STCID) and set-top game instruction data (STGID) are received and stored in the at least a storage medium 110. STCID and STGID are optionally received from a receiver in connection with the gaming console 100, the receiver in communication wit at least a communication channel, or they are received from an external storage medium 140. Next, STICD and the STGID are executed by the at least a processor 120, step 302. The gaming console 100 now emulates a set-top box. For example the executable instructions define which data formats are possibly supported by the emulated set-top box, and contains information about how to decode an encoded data stream received by the gaming console 100, the gaming console emulating a set-top box. Next, the GC 100 receives an encoded data stream, step 304, and decodes the encoded data stream, step 305. The encoded data stream is for example a MPEG data stream relating to a DTV broadcast. In step 306, the GC 100 provides output data for visualization and audio presentation. The output data are provided to the monitor 150 and to the sound system 160. Providing output data is equivalent to displaying video information extracted from the decoded data stream. It will be apparent to those of skill in the art that current GCs are provided with powerful video processors for use in game execution.

When offering DTV services, the question of conditional access (CA) deserves special attention. CA is a technology used to control access to DTV services to authorized users by encrypting transmitted programs. CA has for example been used for years for pay-TV services, following standards developed by the Advanced Television Systems Committee (ATSC), an organization that was created in 1982 to promote the establishment of technical standards for all aspects of advanced television systems. There are numerous ATSC compliant CA systems available for a broadcaster to choose from. A CA system provider provides equipment and software to a broadcaster, who then implements the CA system into his equipment. CA is not designed solely for DTV. It can be used for digital radio broadcasts, digital data broadcasts, and non-broadcast information and interactive services.

A CA system includes several basic components. The subscriber management system (SMS) is a subsystem of the CA system that manages the subscriber's information and requests entitlement management messages (EMM) from a subscriber authorization system (SAS). EMM provides general information about a subscriber and status of the subscription. The SAS is a subsystem of the CA system that translates information about the subscriber into an EMM at a request of the SMS. The SAS also ensures that a subscriber's security module receives authorization needed to view a program. Further, the SAS acts as a backup system in case of failure. A security module, usually in the form of a smart card, extracts the EMM and an entitlement control message ECM necessary for decrypting transmitted programs. The security module is either embedded within a set-top box or in a PC card that plugs into a set-top box. Optionally, when a gaming console is used to emulate a set-top box, the security module in incorporated into the gaming client, and is loaded as part of the set-top client instruction data.

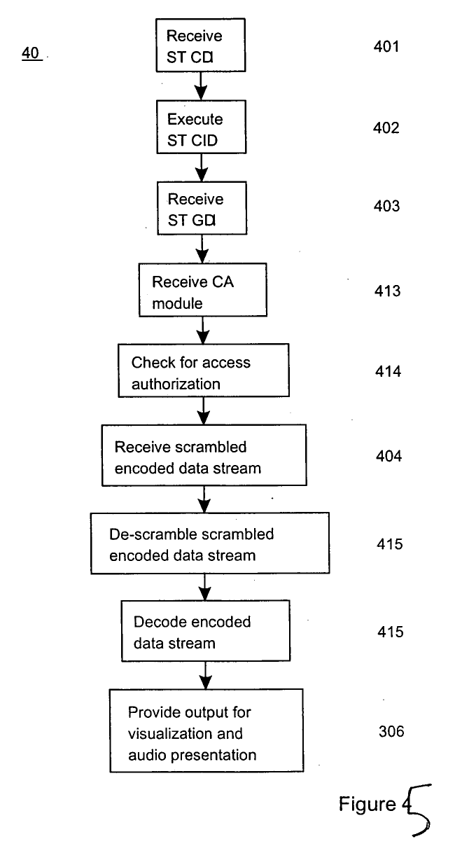

Referring now to FIG. 5, a flow chart is displayed illustrating a procedure 40 illustrating a method of emulating a set-top box with a gaming console under consideration of conditional access (CA). The procedure 40 is related to the above-described procedure 30, and exemplifications and illustrations made for the procedure 30 equally apply to the procedure 40. The first steps of procedure 40, receiving STCID, step 401, executing STCID, step 402, and receiving STGID, step 403, are similar to the corresponding steps of procedure 30. After executing steps 401, 402, and 403, the gaming console 100 is conditioned and in a state of emulating a set-top box. Next, a conditional access module (CAM) is received, step 404. The CAM is optionally received over the network or from on external storage medium. The CAM is a client running on the at least a processor 120 for verifying access authorization of the gaming console 100, and for descrambling a scrambled data stream. Next, the CAM verifies for access authorization, step 414. For example, the CAM verifies the validity of an access code providing from a smart card, the smart card in communication with the at least a processor 120 and the at least a storage medium 110 through the interface 170. A person of skill in the art envisions with ease other methods of authorization access verification. Next, a scrambled, encoded data stream is received, step 404. The CAM descrambles the scrambled, encoded data stream, step 415. The descrambled, encoded data stream is decoded, step 405, the step being performed by the set-top game instruction data in execution by the at least a processor 120. In step 406, the GC 100 provides output data for visualization and audio presentation. The output data are provided to the monitor 150 and to the sound system 160. Providing output data is equivalent to displaying video information and playing audio information extracted from the decoded data stream.

Due to the widespread penetration of GCs in the marketplace, their low cost, and their general desirability, the present invention provides for another use for same, which effectively eliminates a need to purchase or otherwise pay for a separate set-top box for use with a television set. Further, the GC is then coupled to the DTV network allowing for interactive network type gaming and provision of other broadband based gaming functions.

Although the instant invention has been described with respect to a specific embodiment thereof, various changes and modifications are optionally carried out by those skilled in the art without departing from the scope of the invention. Therefore, it is intended that the instant invention encompass such changes and modifications as fall within the scope of the appended claims.

What is claimed is:

1. A digital television set system comprising:
a receiver for receiving digital television signals from at least a communication channel; and
a gaming console for use as a gaming client, the gaming console connected to the receiver and comprising:
at least a volatile storage medium for having stored therein client instruction data relating to a gaming client and game instruction data relating to a current game in execution;
at least an external storage medium reading circuit for sensing data from an external storage medium and for storing the received data in the at least a volatile storage medium; and
at least a processor in communication with the at least a volatile storage medium, the processor for retrieving game instruction data therefrom for executing a game on the gaming console, and for retrieving client instruction data therefrom for executing a gaming client function on the gaming console;
wherein when set-top client instruction data and set-top application instruction data are stored in the at least a storage medium and are executed on the at least a processor, the gaming console emulates a set-top box for use in displaying video information extracted from digital television signals.

2. A digital television set system according to claim 1, wherein the gaming console comprises an external local storage medium, and wherein the client instruction data and game instruction data are loaded from the external local storage medium into the at least a volatile storage medium.

3. A digital television set system according to claim 2, wherein the external local storage medium is a compact disc.

4. A digital television set system according to claim 2, wherein the external local storage medium is a removable read-only memory cartridge.

5. A digital television set system according to claim 1, wherein the gaming console comprises a transceiver for establishing a connection to a broadband access network.

6. A method for emulating a set-top box on a gaming console, the gaming console being part of digital television set system and coupled to a receiver for receiving digital television signals from at least a communication channel, the gaming console comprising at least a processor and at least a storage medium, and being in connection with a monitor and a sound system, the method comprising the steps of:
receiving first instruction data from an external storage medium read by the gaming console and including one of set-top instruction data for receiving and decoding digital broadcast data when executed on the gaming console and communication data for use in retrieving via the receiver the set-top instruction data for receiving and decoding digital broadcast data when executed on the gaming console;
executing the set-top instruction data on the gaming console;
receiving encoded digital broadcast data via the receiver;
decoding the received, encoded digital broadcast data; and
displaying the decoded digital broadcast data on the monitor and on the sound system.

7. The method according to claim 6, wherein the set-top instruction data are received from the receiver in connection with the gaming console.

8. The method according to claim 6, wherein the set-top instruction data are received from an external storage medium in connection with the gaming console.

9. The method according to claim 6, further comprising the steps of:
receiving a conditional access module; and
verifying access authorization for encoded digital broadcast data with the conditional access module.

10. The method according to claim 9, wherein access authorization is verified using authorization data provided from a smart card, the smart card in connection with the gaming console through an interface.

11. The method according to claim 9, wherein the encoded digital broadcast data are scrambled, encoded digital broadcast data.

12. The method according to claim 11, wherein the scrambled, encoded digital broadcast data is descrambled by the conditional access module before being decoded.

13. The method according to claim 6, wherein the gaming console is in communication with a monitor, and wherein the gaming console is emulating a set-top box for receiving and displaying on the monitor services other than gaming services.

14. The method according to claim 13, wherein the monitor is a monitor included in an analog transmission television set.

15. The method according to claim 13, wherein the gaming console is in communication with at least another network

16. The method according to claim 15, wherein the at least another network is a community antenna television network.

17. The method according to claim 15, wherein the at least another network is a telephone line network.

18. The method according to claim 15, wherein the at least another network is a wireless network.

19. The method according to claim 13, wherein the services relate to digital television broadcast.

20. The method according to claim 13, wherein the services relate to Transmission Control Protocol/Internet Protocol access.

21. The method according to claim 13, wherein the services relate to interactive television applications.
